(19) United States
(12) Patent Application Publication
(10) Pub. No.: US 2016/0063886 A1
(43) Pub. Date: Mar. 3, 2016

(54) Color Reading and Language Teaching Method

(71) Applicant: Kelly Russell, Richfield, NC (US)

(72) Inventor: Kelly Russell, Richfield, NC (US)

(21) Appl. No.: 14/836,543

(22) Filed: Aug. 26, 2015

Related U.S. Application Data
(60) Provisional application No. 62/041,867, filed on Aug. 26, 2014.

(51) Int. Cl. G09B 17/00; G09B 5/02

(52) U.S. Cl. CPC G09B 17/003; G09B 5/02

(57) ABSTRACT

A method and computer system for teaching reading and language skills utilizing the application of color to traditional black text is provided. The method may be implemented by software and includes generating a new document from a source text document wherein the text of the new document is assigned a color according to one or more patterns. The user has the option to select from a first mode of operation wherein each letter in the new document is assigned an individual color, a second mode of operation wherein distinct groups of letters are assigned individual colors, and a third mode of operation wherein distinct words are assigned individual colors.

### CROSS REFERENCE TO RELATED APPLICATION

This application claims the benefit of U.S. Provisional Application No. 62/041,867 filed on Aug. 26, 2014. The above identified patent application is herein incorporated by reference in its entirety to provide continuity of disclosure.

### FIELD OF THE INVENTION

The present invention relates to methods for teaching and improving reading comprehension and language skills. More particularly, the present invention relates applying methods for teaching language and reading comprehension skills using text color patterns to black and white text.

### BACKGROUND OF THE INVENTION

Text is traditionally displayed on paper or on a computer screen as black letters on a white background. Reading black and white text is typically not an issue for those with developed reading and language skills. However, children and adults with learning disabilities or visual impairments may have difficulty reading, comprehending, and recalling traditional black and white text because it offers little engagement for the reader beyond the printed words themselves. It is therefore desirable to provide an alternative to traditional black and white text that provides additional visual aids that assist with reading comprehension and language learning.

The English language is made up of phonemes, which are the smallest units of sound that can differentiate meaning. For example, the “k” sound in the beginning of the word “cat,” the “a” sound in the middle and the hard “t” sound at the end are three different phonemes. Other examples of s include the “ch” sound made by the word “change” and the “sh” sound at the beginning of the word “shout.” Phonemic awareness, or the ability to hear, identify, and manipulate s, greatly improves word recognition, reading comprehension, spelling, and pronunciation. One method of teaching reading and language skills is to first teach the phonemes that form each sound in a word when it is spoken aloud. If a reader then encounters a word he or she does not know, the reader may be able to deduce the pronunciation of the word by identifying the phonemes that form the word. Traditional black and white text lacks a mechanism for readers to identify phonemes and use them to deduce a word's pronunciation or contextual meaning. It is therefore desired to provide a method for altering black and white text to allow readers to distinguish the different phonemes that make up each word of the text.

Another drawback of the traditional display of black and white text is that it provides little reader engagement. Beyond the printed words, the use of uniform black letters does not allow for creative expression or manipulation of the letters themselves. Providing distinguishing characteristics for different letters or groups of letters, such as color-coding aids, assists readers in identifying different words. Adding color to black and white text further increases the visual appeal of the text, encouraging young readers to engage with the text.

Using colors to represent basic sounds of a language provides benefits to those learning or improving language skills. It provides an immediately visual distinction between consonant sounds and vowel sounds. The use of colors allows readers to learn to recognize different words using inferential visual cues rather than memorizing complex and seemingly abstract rules. A student may thus spend less time learning as a sense of language develops over repeated use of the color system.

Some types of color assisted teaching systems are known in the prior art. These aids utilize various color patterns to help readers identify different words and grammatical structures. These prior art teaching system are typically embodied as teaching aid texts that are printed with the text already colored according to the pattern used by the teaching systems. The prior art teaching systems do not provide a way for students to apply the system to black and white text or any other text that has not been pre-printed according to the color pattern used by the system.

Other prior art methods of applying color to words and letters for teach purposes involve placing translucent strips over words printed on paper in order to imitate color, while the black and white text remains the same underneath. However, the prior art devices and methods do not provide a way to alter the underlying black and white text. Further, the method may not be applied to a text document stored on a computer. The text document must first be printed, which consumes time and other resources. Therefore, the prior art fails to provide a method for starting with an existing black and white text document and individually coloring the letters and/or words of the document to form a new document, wherein the color of the text in the document corresponds with patterns that aid readers in learning reading and language skills.

### SUMMARY OF THE INVENTION

In view of the foregoing disadvantages inherent in the known types of reading teaching methods now present in the prior art, the present invention provides a method for teaching reading and language skills wherein the same can be utilized for providing a color-assisted reading and language program.

One object of the present invention is to provide a computer implemented method comprising the steps of retrieving a source document and selecting one of a plurality of modes of operation, wherein selection of a first mode of operation assigns a color to each letter in the text.

Another object of the present invention is to provide a computer implemented method comprising the steps of retrieving a source document and selecting one of a plurality of modes of operation, wherein selection of a second mode of operation assigns a color to phonemes in the text.

Still another object of the present invention is to provide a computer implemented method comprising the steps of retrieving a source document and selecting one of a plurality of modes of operation, wherein selection of a third mode of operation assigns a color to each word of the text.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an embodiment of the first mode of operation of the present invention displayed on an electronic display.

FIG. 2 shows an embodiment of the second mode of operation of the present invention displayed on an electronic display.

FIG. 3 shows an embodiment of the third mode of operation of the present invention displayed on an electronic display.

FIG. 4 shows a flowchart depicting an embodiment of a method according to the present invention.

### DETAILED DESCRIPTION OF THE INVENTION

Reference is made herein to the attached drawings. Like reference numerals are used throughout the drawings to depict like or similar elements of the corner trim cover. For the purposes of presenting a brief and clear description of the present invention, the preferred embodiment will be discussed as used for repairing damaged vinyl siding corner trim. The figures are intended for representative purposes only and should not be considered to be limiting in any respect.

As used As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

The present invention is a logic executed by a processor that receives a source document, such as a PDF file, having monochromatic text and then colorizes the text of the document according to one or more modes that are selectable by a user. The document having colorized text can thereafter be viewed on an electronic display, printed, or otherwise viewed by a user. In one embodiment of the present invention, the logic comprises a software program that runs in the background of the computer and colorizes the text of each eligible document that is opened by a user according to the selected mode. In another embodiment, the user uploads a source document to a computer having a memory on which the logic is stored, whereupon the logic opens the source document, colorizes the text according to the selected mode, and then returns the edited source file or a newly generated file containing the colorized text from the source file to the user.

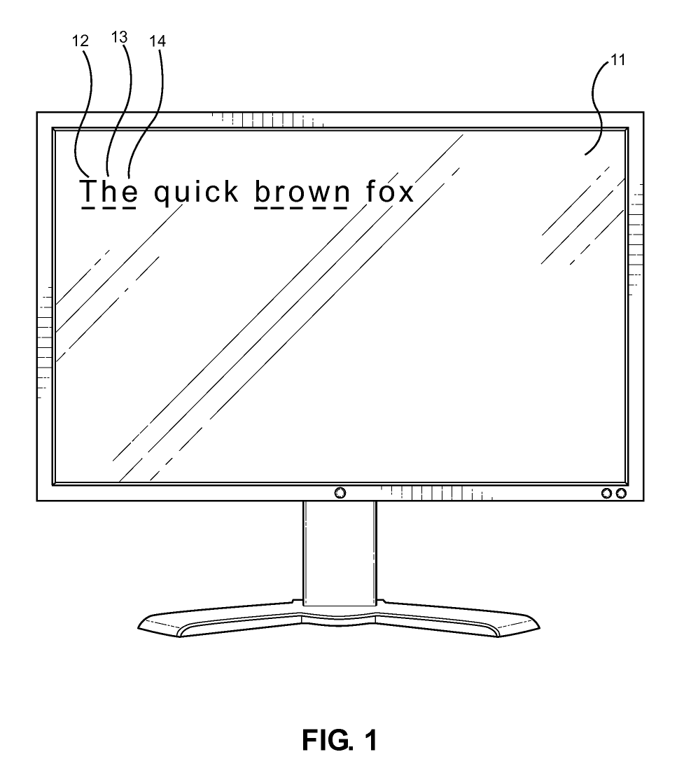

Referring now to FIG. 1, there is shown a string of text displayed on an electronic display, wherein the underlined portions represent an example of color assignment made according to the first mode of operation. The present invention can be applied to any black and white text document. In one embodiment, a user receives a source document, such as a PDF file, that contains conventional black and white text. In one embodiment, the source document may be retrieved from a data storage via a server. The user can then select from one of three modes of operation depending upon the desired color patterning. The first mode of operation assigns a color on a letter-by-letter basis. In an illustrative embodiment of the first mode of operation, each of the twenty-six letters of the alphabet is assigned a unique color and the letters of each word are colored according to the assigned color, e.g. the letter “A” is assigned a first color, the letter “B” is assigned a second color, and so on. Both the uppercase and lowercase versions of a letter will be assigned the same color. For example, in displayed string of text, the word “The,” the letter “T” 12, the letter “h” 13, and the letter “e” 14 are each assigned different colors. This process is repeated for each of the words in the document. This encourages readers to distinguish between different letters by providing an additional defining characteristic not present in conventional black and white text.

In another embodiment of the first mode of operation, the logic assigns a particular color to different types of individual letters. For example, all of the vowels in the text may be assigned the same color in order to help readers distinguish between vowels and consonants. The first mode of operation is designed to be an introduction to distinguishing, identifying, and memorizing different letters of the alphabet, which aids in a reader's understanding of the words themselves.

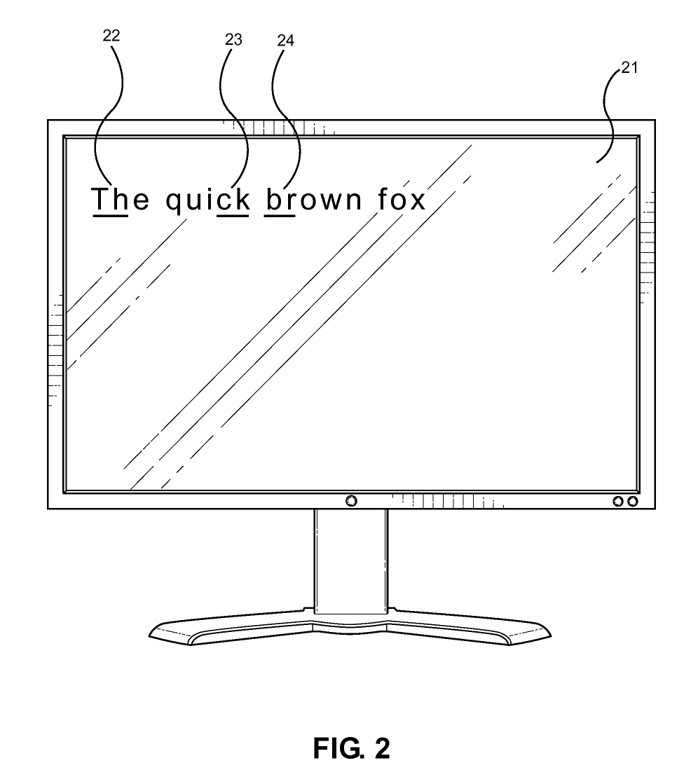

Referring now to FIG. 2, there is shown a string of text displayed on an electronic display, wherein with the underlined portions represent an example of color assignment made according to the second mode of operation. In the second mode of operation, the text of the source document is colorized based upon groupings of letters within each word. In one embodiment of the second mode, the groupings of letters by which the text is colorized are the phonemes of the words. Each phoneme is assigned a unique color, which is consistently repeated throughout the document for each phoneme in order to assist users in recognizing each phoneme. For example, the underlined phoneme “Th” 22 may be assigned one color, while the underlined phonemes “ck” 23 and “br” 24 may each be assigned two other distinct colors. A user is then able to visually identify different groupings of letters that form a distinct sound when spoken. This mode of operation provides distinguishing characteristics to different phonemes, which aids in understanding pronunciation and how different letters form unique sounds when combined.

In an alternative embodiment, individual prefixes and suffixes may be assigned distinct colors. Using the word “uncaring” as an example, the suffix “-ing” and the prefix “un-” may each be assigned a distinct color. This provides a method of visually identifying suffixes and prefixes and the particular sounds they make when combined with base works. As with the first mode of operation, the color selection may vary based on particular patterns associated with improved memorization and recall.

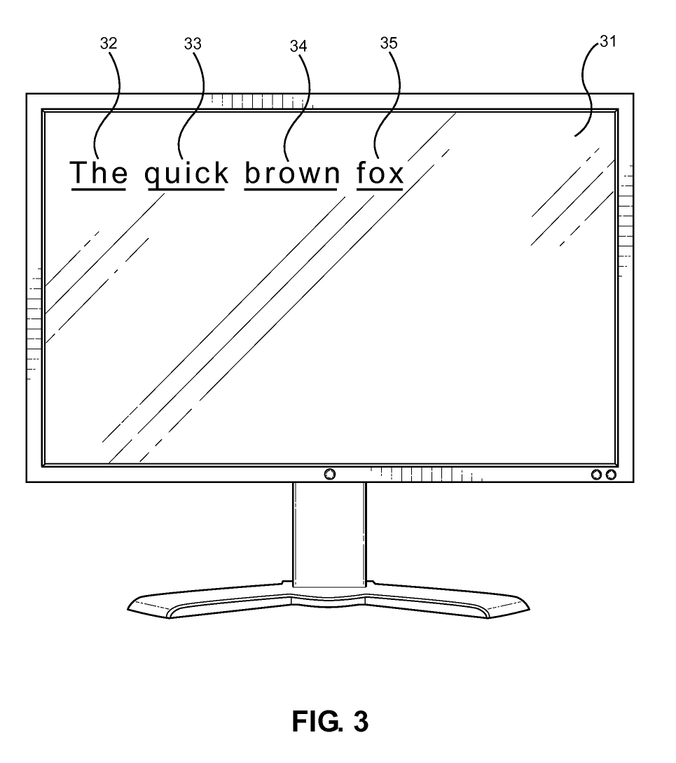

Referring now to FIG. 3, there is shown a string of text displayed on an electronic display, wherein the underlined portions represent an example of color assignment made according to the third mode of operation. If users select this mode of operation, each distinct word will be assigned a different color. For example, in one embodiment the word “quick” 33 and the word “brown” 44 may each be assigned a different color. In another embodiment, words from specific categories of parts of speech such as nouns, verbs, or adjectives may be assigned a color unique to that part of speech. For example, the word “quick” 33 and the word “brown” 44 may each be assigned the same color as they are both adjectives. The word “fox” 35, which is a noun, would then be assigned the same color as other nouns in the text. In this embodiment, different colors are used to enable readers to easily distinguish between different parts of speech, which include nouns, verbs, adjectives, adverbs, pronouns, prepositions, conjunctions, and interjections.

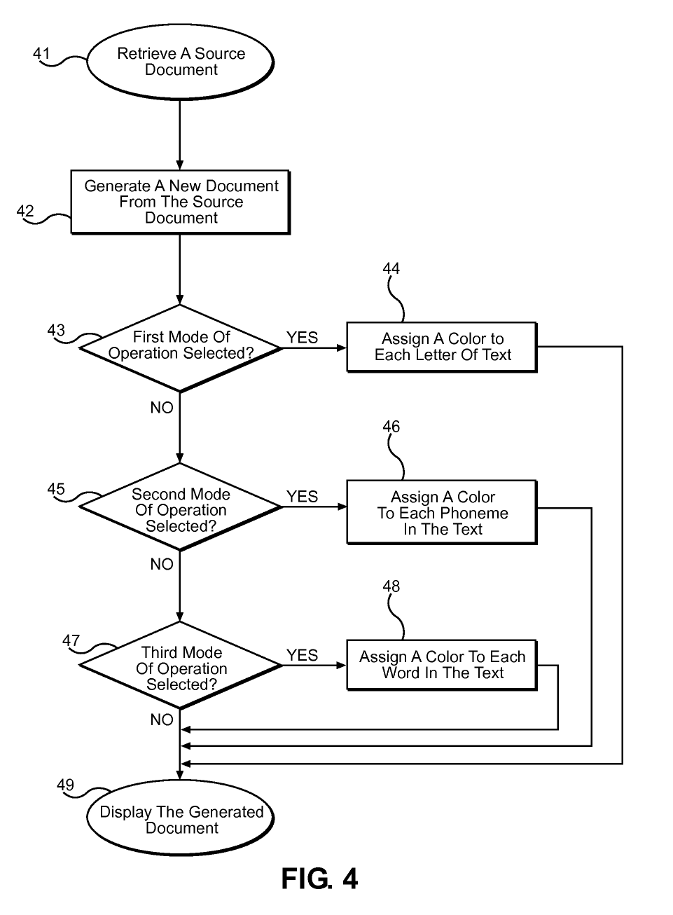

Referring now to FIG. 4, a flowchart depicting one embodiment of a method according to the present invention is shown. The method may be performed by a computer system comprising a processor and a non-transitory computer-readable medium having a logic that is operatively connected to the processor. When the logic is executed by the processor, the computer system performs the method. The first step of the method is to receive a source document 41. A user may receive a source document via downloading from a remote server or from a locally saved file. The source document may be any file type that contains text, such as .doc, .docx, .txt, .pdf, or the like. If the source document is a static image file of a document, such as a .pdf file of a digitally scanned document, pattern recognition software such as optical character recognition (OCR) may be used to identify the characters of the text.

The next step is to select one of a plurality of modes of operation. In one embodiment of the invention, the user chooses between three modes of operation corresponding to different levels of reading and language ability. If a user selects a first mode of operation 43, a color is assigned to each letter of text 44. Which color is assigned to which letter may vary based upon teaching methods. For example, vowels are assigned one color while consonants are assigned another color or each letter of the alphabet is assigned its own color.

If a user selects the second mode of operation 45, a color is assigned to each in the text 46. As with the first mode of operation, the exact color assignment may be determined according to one or more patterns used by one or more teaching systems. In an alternative embodiments, colors may be assigned to other groupings of letters. For example, a color may be assigned to each suffix or prefix in a word so that users learn to identify variations on base words.

If a user selects the third mode of operation 47, a color is assigned to each word of the text 48. As with the second and third mode of operation, the exact color assignment may be determined according to one or more patterns used by one or more teaching systems. In some embodiments, one pattern may include applying one of seven colors to each of seven parts of speech. An example would be selecting from the group of purple, indigo, blue, green, black, orange, and red, wherein each noun in the text may be assigned purple, each verb may be assigned green, each pronoun may be assigned orange, etc.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

I claim:

1) A computer comprising:
a processor;
a non-transitory computer readable medium operatively connected to the processor;
a logic stored in the non-transitory computer readable medium that, when executed by the processor, causes the computer to perform a method, the method comprising the steps of:
receiving a source document comprising text;
if a first mode of operation is selected, assigning a color to each letter of the text;
if a second mode of operation is selected, assigning a color to each phoneme of the text;
if a third mode of operation is selected, assigning a color to each word of the text;
colorizing the text of the source document based upon the selected mode of operation.

2) The computer system of claim 1, wherein the method performed by the computer system further comprises assigning a first color to consonants and assigning a second color to vowels when the first mode of operation is selected.

3) The computer system of claim 1, wherein the method performed by the computer system further comprises assigning a first color to prefixes and assigning a second color to suffixes when the second mode of operation is selected.

4) The computer system of claim 1, wherein the method performed by the computer system further comprises assigning a first color to nouns, a second color to verbs, a third color to adjectives, a fourth color to adverbs, a fifth color to pronouns, a sixth color to prepositions, and a seventh color to interjections when the third mode of operation is selected.

5) The computer system of claim 4, wherein the method performed by the computer system further comprises selecting one or more colors from a group comprising purple, indigo, blue, green, black, orange, and red.

6) A non-transitory computer readable medium that, when executed by a processor of a computer system, causes the computer system to perform a method, the method comprising the steps of:
receiving a source document comprising text;
if a first mode of operation is selected, assigning a color to each letter of the text;
if a second mode of operation is selected, assigning a color to each phoneme of the text;
if a third mode of operation is selected, assigning a color to each word of the text;
colorizing the text of the source document based upon the selected mode of operation.

7) The non-transitory computer readable medium of claim 6, wherein the method performed by the computer system further comprises assigning a first color to consonants and assigning a second color to vowels when the first mode of operation is selected.

8) The non-transitory computer readable medium of claim 6, wherein the method performed by the computer system further comprises assigning a first color to prefixes and assigning a second color to suffixes when the second mode of operation is selected.

9) The non-transitory computer readable medium of claim 6, wherein the method performed by the computer system further comprises assigning a first color to nouns, a second color to verbs, a third color to adjectives, a fourth color to adverbs, a fifth color to pronouns, a sixth color to prepositions, and a seventh color to interjections when the third mode of operation is selected.

10) The non-transitory computer readable medium of claim 9, The computer system of claim 4, wherein the method performed by the computer system further comprises selecting one or more colors from a group comprising purple, indigo, blue, green, black, orange, and red.

11) A computer implemented method comprising the steps of:
receiving a source document comprising text;
if a first mode of operation is selected, assigning a color to each letter of the text;
if a second mode of operation is selected, assigning a color to each phoneme of the text;
if a third mode of operation is selected, assigning a color to each word of the text;
colorizing the text of the source document based upon the selected mode of operation.

12) The method of claim 11, wherein the selection of the first mode of operation further comprises assigning a first color to consonants and assigning a second color to vowels.

13) The method of claim 11, wherein the selection of the second mode of operation further comprises assigning a first color to prefixes and assigning a second color to suffixes.

14) The method of claim 11, wherein the selection of the third mode of operation further comprises assigning a first color to nouns, a second color to verbs, a third color to adjectives, a fourth color to adverbs, a fifth color to pronouns, a sixth color to prepositions, and a seventh color to interjections.

15) The method of claim 14, wherein each color is selected from a group comprising purple, indigo, blue, green, black, orange, and red.
